(19) United States
(12) Patent Application Publication
(10) Pub. No.: US 2025/0026619 A1
(43) Pub. Date: Jan. 23, 2025

(54) SAFETY SYSTEM FOR WORKING MACHINE

(71) Applicant: MANITOU ITALIA S.R.L., CASTELFRANCO EMILIA (MO) (IT)

(72) Inventor: Marco IOTTI, Reggio Emilia (IT)

(21) Appl. No.: 18/769,718

(22) Filed: Jul. 11, 2024

(30) Foreign Application Priority Data
Jul. 21, 2023 (IT) 102023000015342

(51) Int. Cl. B66F 9/06; B66F 9/20

(52) U.S. Cl. CPC B66F 9/063; B66F 9/20

(57) ABSTRACT

Described is a self-propelled working machine (1) provided with an organ (10) for moving a load which comprises an activation actuator (14, 16). The force applied by the actuator (14, 16) is constrained by a predetermined maximum threshold.

This invention relates to an improved safety system for self-propelled working machines.

More in detail, the invention relates especially, even if not exclusively, to a telescopic handler.

There are prior art telescopic handlers consisting of a vehicle provided with a frame, or “chassis,” movable on wheels, of a driver's cab for the operator and a manoeuvring boom which can be extended for lifting and lowering a load.

In some models, the manoeuvring boom is hinged directly to the chassis, whilst other models are provided with a platform, or “turret”, mounted rotatably on the chassis, or “undercarriage” in this case, which has the cab and to which the manoeuvring boom is hinged.

An attachment is provided at the distal end of the boom for lifting or moving loads, such as, for example, a fork, a cage, a winch, etc.

It is known that telescopic handlers are equipped with a system for limiting the longitudinal moment which monitors variable geometrical parameters of the machine (sliding length of the boom, angle of lifting the boom relative to the horizontal, etc.), calculates the maximum permissible load instantaneously and determines whether or not there is a risk of instability.

In practice, under certain stabilising conditions, depending on the position of the load carried by the boom and its weight, it is possible to determine whether the machine is subject to a risk of overturning. If the working conditions are close to those in which there would be a risk of instability, the movements of the manoeuvring boom are automatically prevented, so as to prevent the above-mentioned risks.

This limiting system prevents the instability and is not specifically designed to avoid the risks of structural failure of the machine, for the reason that, in almost all the cases, they would emerge under conditions of stress which could occur only if the limiting system were deactivated and the machine were used for moving excessive loads and/or in very aggravating positions of the longitudinal moment. For this reason, normally, the system for limiting the longitudinal moment also prevents the structural yield.

However, it has recently been noticed that in specific applications and under certain operating conditions, it could happen that the risk of failure is not always automatically avoided in advance by the limiting system described above. In particular, currently, the market requires the supply of machines which are designed on the basis of a compromise between performance and costs which does not allow the use of components formed by thick, heavy structures which are expensive for their manufacture.

For this reason, a need is felt for a safety system which can also prevent the risk of failure, if the machine were in the particular working conditions wherein this might not be automatically covered by the system for limiting the longitudinal moment.

The technical purpose which forms the basis of the invention is to provide a self-propelled working machine and a method for operation of a self-propelled working machine which satisfy the above-mentioned need.

This specified technical purpose is attained by the invention made according to the appended claims.

Further features and advantages of the present invention are more apparent in the non-limiting description of a preferred embodiment of the proposed machine, as illustrated in the accompanying drawings, in which:

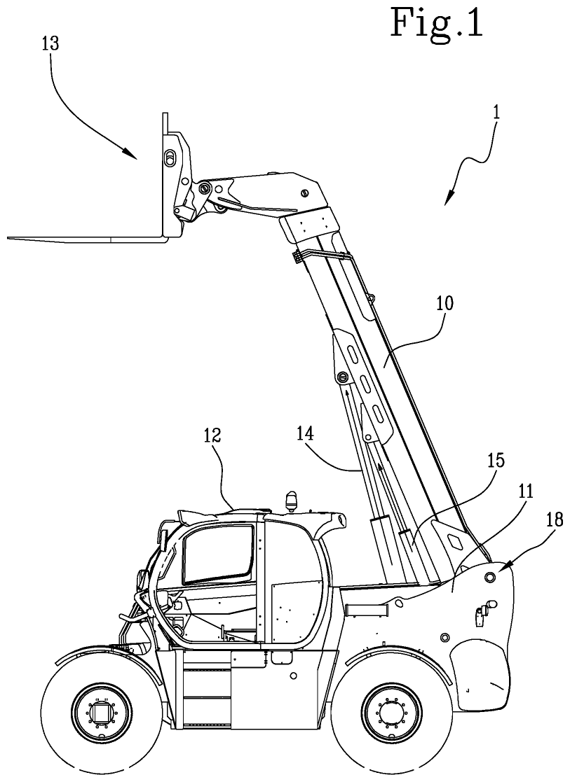

FIG. 1 is a side view of the working machine according to the invention;

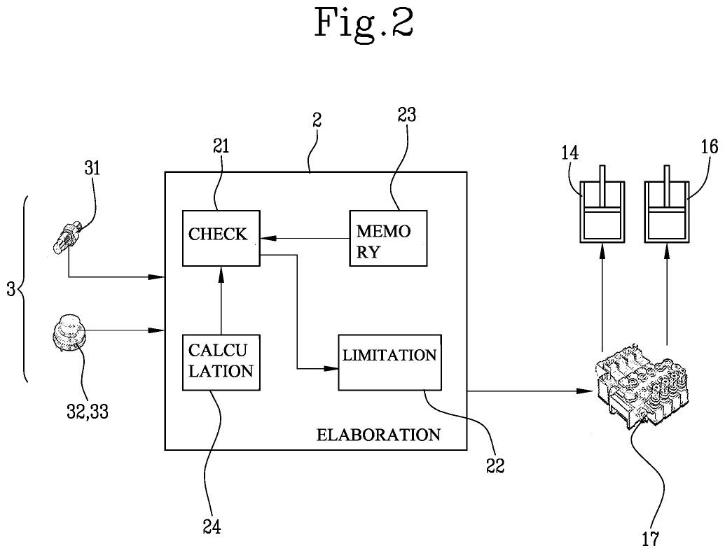

FIG. 2 is a diagram representing the anti-tipping function of the safety system according to the invention; and

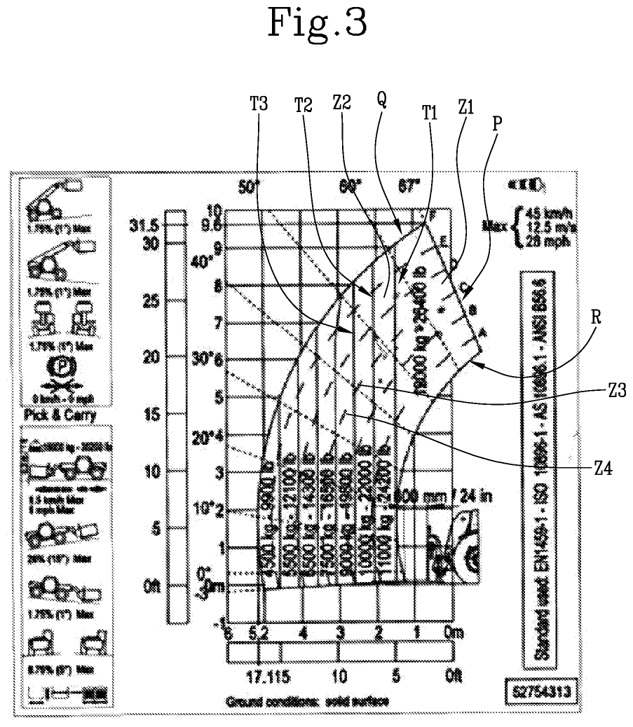

FIG. 3 is a load diagram of the proposed machine.

With reference to the accompanying drawings, reference numeral 1 denotes in its entirety a self-propelled working machine made according to the invention.

The machine 1 shown in the drawings is a telescopic handler of the so-called “fixed” type, equipped with a telescopic lifting boom 10 hinged directly to a frame 11, movable on wheels, which houses the driver's cab 12. Moreover, the boom 10 is equipped, at its distal end, with a loading attachment 13.

Optionally, the frame 11 may also be equipped with outriggers comprising a plurality of stabilising arms; for example, the machine 1 may be equipped with so-called “scissor-like” outriggers.

According to certain embodiments, in place of the wheels 11 there may be tracks or other locomotion attachment.

The machine 1 may be provided with any propulsion system, in particular internal combustion, electrical or hybrid system.

The term attachment 13 means both an device for engaging a load, such as a fork, an boom equipped with hooks, a winch, clamps, etc. and a device for lifting persons and, if necessary, also a load, such as a load platform.

Still more in detail, the boom 10 may have at its distal end, a coupling device, also of the type normally in use in the telehandlers manufactured by the Applicant, which allows the replacement of the attachment 13 and the connection thereof to the hydraulic and electronic apparatuses of the machine 1.

The boom 10 is articulated so as to oscillate vertically, under the actuation of at least one hydraulic cylinder 14 or a similar actuator, between a lower position, substantially horizontal, and an upper position wherein the boom 10 is close to the vertical. Optionally, the machine 1 may include two lifting cylinders 14 or similar actuators. FIG. 1 also shows a compensation cylinder 15 connected hydraulically to an actuator for adjusting the alignment of the attachment 13.

The boom 10 is extensible and retractable and, more precisely, comprises a plurality of segments inserted one in the other, coaxial with one another and designed to translate along the axial direction.

The elongation and retraction of the boom 10 are also produced by one or more hydraulic cylinders 16 (see FIG. 2), or other actuators, or also by a telescopic cylinder (or other actuator with several stages).

The machine 1 also comprises an electro-hydraulic distributor 17 to which are individually connected the hydraulic actuators used in the machine 1, according to known methods. The distributor is fed by a pump actuated by a motor, which are located on board the machine 1. However, embodiments of the invention in which one or more of the above-mentioned actuators are of the electric type instead of hydraulic are not excluded.

However, it should be noted that the invention can be used with a different type of working machine, generally provided with an organ 10 for movement of the load.

In particular, the machine 1 proposed could also be a “rotary” telescopic handler, that is to say, a handler equipped with the rotary turret which has been referred to during discussion of the prior art. Hereinafter, for simplicity of description, reference will be made mainly to the example in which the machine 1 proposed is a handler of the fixed type.

The machine 1 includes a processing unit 2 which is designed to transmit control signals to the distributor which consequently commands the actuators, in such a way that they operate the boom 10, the outriggers, the translation motor and the accessory 13 and other devices included in the machine 1, according to the commands issued by the operator who sits in the cab.

In practice, the machine 1 includes in the relative cab 12, available to the operator, commands such as joystick, pedals, pushbuttons, etc; when the operator acts on the commands, the processing unit generates control signals which are received by the distributor, which then adjusts consequently the operation of each actuator of the boom 10, of the outriggers, of the accessory 13 etc.

In addition, the invention may, if necessary, comprise the use of a remote control which comprises commands which correspond functionally to those present in the cab 12 and it is designed to transmit control signals to a receiver which is connected to the processing unit.

In practice, the processing unit 2 transmits control signals to the distributor which consequently commands the hydraulic actuators of the machine 1 in accordance with certain conditions.

The machine 1 according to the invention is equipped with a safety system which is able to prevent the risks of structural yield of the manoeuvring boom 10 and, preferably, also prevent the risks of instability. The safety system according to the invention is preferably designed in such a way that, based on the working conditions, aggravating movements of the manoeuvring boom 10 are avoided which could produce either a risk of instability or a structural risk.

According to an important aspect of the invention, conceived to guarantee the structural safety, the machine 1 is configured in such a way that the force exerted by at least one of the actuators 14, 16 for activating the manoeuvring boom 10 is constrained by a predetermined maximum threshold.

For this reason, the machine 1 is designed in such a way that the manoeuvring boom 10 (or other load movement organ) exerts a load movement force which is limited by a maximum threshold, at least for some movements.

More specifically, in order to maintain the structural safety of the boom 10, only the extension actuator 16 of the boom 10 may be subject to the above-mentioned force constraint. In practice, in this case, the boom 10 may apply a predetermined maximum thrust force to the load and, therefore, its maximum degree of elongation will be limited by the constraint and will depend on the weight of the load carried; in other words, under equal conditions of load, the boom 10 will be allowed a maximum operating length which may be less than the maximum geometrical length, that is to say, the one which would be obtained by the complete extension of each segment making up the boom 10. In other words, the maximum threshold is chosen in such a way as to allow or prevent the boom 10 from reaching specific lengths depending on the weight of the load.

This function may be obtained by limiting the working pressure of the cylinder to a predetermined maximum threshold value.

In particular, this can be achieved by configuring the hydraulic circuit which comprises the sliding cylinder 16 of the boom 10 in such a way that the latter is fed with operating fluid with a pressure that is limited by a maximum value which corresponds to the above-mentioned predetermined maximum threshold.

In more detail, the circuit also comprises the above-mentioned distributor 17 and this may be designed for feeding the cylinder with a working fluid with a pressure which is limited by the maximum pressure value, less than the maximum value at which the cylinder 16 could work.

For example, the maximum internal pressure valve of the circuit, which is inside the distributor, may be calibrated in such a way as to define the maximum pressure value for the fluid which feeds the extension cylinder 16. Embodiments are also possible wherein the pressure limitation is achieved by calibrating or configuring other parts of the hydraulic circuit, such as, for example, the extension cylinder 16 or suitable valves, in such a way as to obtain the above-mentioned maximum threshold.

It should also be noted that, if two or more hydraulic cylinders 16 are provided (or, in general, two extension actuators), the limitation of the pressure (or, in any case, the thrust force) of one may be equal to or different from that of the other, however they are made. Similarly, in the case of telescopic cylinders or in any case actuators with several stages, each stage may have a different value of the thrust threshold, for example a different maximum pressure.

Thanks to this advantageous feature, it is possible to avoid the risk of structural yield of the boom 10, since the stresses on the boom 10 depend on the weight of the load and on the extension of the boom, that is to say, on the length of the boom 10 itself, which corresponds in practice to the distance between the load and the hinge which joins the boom 10 to the frame 11 (or other references).

For this reason, since the thrust force of the extension cylinder 16 is limited in the manner explained above, with the increase in the weight of the load the maximum allowed extension of the boom 10 can reduce proportionally. This prevents the mechanical stresses on the boom 10 from becoming such as to jeopardise its structural resistance.

In practice, after reaching the predetermined pressure limit, even if the operator acts on the commands in such a way as to continue the extension of the boom 10, the latter cannot extend further and keeps the load stationary; in this condition, the operator can withdraw the boom 10 but cannot extend it further.

If the load moved is limited, the maximum force which can be applied in pushing mode by the boom 10 may also be such as to allow it to extend up to its maximum possible or “geometrical” length, that is, the design length. With significant weights, the constraint to the thrust force can reduce the length which can be reached to a maximum operating length less than the maximum potential length.

It should be noted that the maximum threshold of the load movement force is predetermined and defined beforehand at the design level of the machine 1.

It should be noted how this result can be obtained automatically, even without the need for the use of sensors and electronic controls; however, the use of a sensors connected to a processing unit is also possible for a finer adjustment or for checking the actual operating conditions or as a feedback.

Thanks to this feature, the invention allows telehandlers to be provided on the market which are designed with a good compromise between performance and costs, without risks for the structural safety. In effect, as will be illustrated below, when explaining a possible operation of the invention, when using that type of machine 1, there might be operating conditions in which there is no risk of overturning but in which the stresses of the boom 10 might become excessive. In those cases, a system for limiting the longitudinal moment would not automatically block the aggravating movements of the boom 10; however, thanks to the force constraint applied to the manoeuvring boom 10 described above, this type of machine 1 is also safe from a structural point of view.

As mentioned above, the safety system according to the invention may also be designed to prevent a risk of instability.

The system comprises means 3 for detecting a position and a weight of the load and also comprises an electronic processing unit 2 (shown in FIG. 2), connected to the detection means and in turn comprising: a checking module 21 configured for comparing the weight of the load with a predetermined reference value, selected on the basis of a position of the load; and a limiting module 22 configured for producing at least one limiting signal suitable for limiting the movement of the movement organ 10 of the machine 1, following the comparison performed by the checking module.

Generally speaking, it should be noted that, in the present description, the processing unit 2 is presented as being subdivided into separate functional modules solely for the purpose of describing the functions clearly and completely.

In practice, the processing unit 2 may consist of a single electronic device, also of the type commonly present on this type of machine, such as, for example, a control unit, suitably programmed to perform the functions described; the various modules can correspond to hardware units and/or software forming part of the programmed device.

Alternatively or in addition, the functions can be performed by a plurality of electronic devices on which the above-mentioned functional modules can be distributed.

Generally speaking, the processing unit 2 may have one or more microprocessors or microcontrollers for execution of the instructions contained in the memory modules and the above-mentioned functional modules may also be distributed on a plurality of local or remote calculators based on the architecture of the network on which they are housed.

As already explained, according to the embodiment of the invention wherein the machine is a telescopic handler 1, for example, the above-mentioned movement organ includes a manoeuvring boom 10 which can be lifted and lowered under the actuation of a first actuator 14; for example the above-mentioned lifting cylinder is extensible and retractable under the actuation of a second actuator 16, for example the lifting cylinder. In this case, the operation of the first and second actuators 14, 16 are subject to the limiting signal produced by the processing unit 2.

More in detail, if the first and the second actuators 14, 16 are of the hydraulic type, the machine 1 comprises the hydraulic distributor 17, which may be designed to adjust the operation of the two hydraulic actuators 14, 16, after receiving the limitation signal from the processing unit 2.

Preferably, the above-mentioned predetermined reference value is a threshold value and the limiting module 22 is configured for limiting the movement of the boom 10 towards aggravating positions of the longitudinal moment of the machine 1, if the weight measured corresponds to the threshold value, in order to avoid a condition in which a risk of overturning can arise.

The term “aggravating positions” means positions in which the tipping moment, in particular the longitudinal moment of the machine 1, increases with respect to the position adopted by the load previously. A greater elongation of the boom 10 or a lowering of the boom 10 may lead to an increase in the direction indicated.

The longitudinal moment of the machine, as is known, may be defined with respect to an ideal axis of rotation which passes through the front wheels or, if present, the front outriggers.

Preferably, the limiting module 22 is configured to prevent the boom 10 from moving the load into aggravating positions, once it has been verified that the weight has reached the threshold value, which, it should be noted, is a function of the position. In other words, threshold values are defined, which are different or equal, for a multiplicity of different positions which can be adopted by the load in space when it is moved by the boom 10. In practice, a matrix or a vector of threshold values to be compared with the weight is defined. The threshold values are preferably weight values.

For this reason, when a weight corresponding to the threshold value reaches the position associated with that value, even if the operator acts on the commands for lowering or moving away the load, by rotating the boom downwards or by extending it, the load remains stationary. The operator can only raise the boom 10 or reduce its extension. If, on the other hand, the weight of the load is less than the threshold value, the limiting module does not emit the limiting signal and, therefore, the movement of the boom 10 is not automatically prevented. Stopping the movements of the boom 10 towards aggravating positions is the type of limitation of the movements of the preferential boom 10, but other types of movement restriction could also be applied.

In practice, the processing unit 2 can include a memory module 23 in which are recorded different reference values of the weight of the load for different positions which can be adopted by the load in space, to define the above-mentioned matrix (or vector). The detection means 3 allow the weight of the load which is lifted to be measured and allow the position, instant by instant, to be detected. Based on the instantaneous position detected, the checking module 21 compares the weight of the load with the reference weight and, if they are equal, the limiting module 22 emits a limiting signal which influences in a restrictive sense the movements of the boom 10.

The blocking of the movements of the boom 10 actuated by a safety system is called movement “cut” or “stop”. As well as the stop, other types of movement limitation are possible.

According to a preferential aspect of the invention, the above-mentioned reference value is independent of the angular position of the manoeuvring boom 10. In other words, the reference value varies with the variation of the linear distance of the load relative to a predetermined reference, for example a distance along a horizontal plane, or in any case a plane parallel to the ground. For this reason, as described in more detail below, the stop of the movement of the boom 10 produced by the processing unit 2 is “vertical”, that is to say, it defines a vertical plane in space, beyond which the load may not go. More in detail, the above-mentioned distance may be the projection along a horizontal plane of the distance between the position of the load and the position of the hinge 18 which joins the boom 10 to the frame 11. The above-mentioned detection means may include one or more of the following components: a pressure sensor 31 of the hydraulic lifting cylinder 14 of the boom 10, a length sensor 32 to determine the instantaneous length of the boom 10 and an angular sensor 33 to detect the angular position of the boom 10 (see FIG. 2). More in detail, the lifting cylinder 14 may be equipped with two sensors 31 which detect the pressure, one located at the base and one located at the piston. If there are two lifting cylinders 14, each may have two sensors 31 positioned in the manner explained. The length sensor 31 may be a cable winding sensor, which may also incorporate the angular sensor 33.

In addition or alternatively, there could also be a sensor applied to the rear axle of the machine which detects directly or indirectly a reduction of the load, such as, for example, a load cell or an extensometer.

Moreover, if the machine 1 is equipped with outriggers, the processing unit 2 can also be configured in such a way as to limit the movements of the movement organ 10 also on the basis of the information that the outriggers are placed on the ground and, if necessary, of a position of them, for example relative to the degree of extension, if they are of the pull-out type. In this case, special sensors would be provided to detect these circumstances.

The processing unit 2 may comprise a calculation module 24 configured for calculating the weight and the position of the load on the basis of the parameters acquired from the detection means. More in detail, the memory module 23 may contain information relative to the weight and position of the barycentre of the boom 10 and of the accessory mounted at its end. In this case, the calculation module 24 is configured to determine the reaction force vector(s) of the lifting cylinder(s) 14 on the basis of the measurements of the pressure sensor(s) 31 and for calculating consequently the weight of the load, on the basis of the parameters relative to the boom 10 and to the accessory 13 included in the memory module,

The calculation module 24 may be configured to determine the position of the load (relative to a predetermined reference, for example the hinge between boom 10 and frame 11) on the basis of the signals produced by the length sensor 32 and by the angular sensor 33.

A possible operation of the invention is described below with the aid of FIG. 3, which represents an example of a loading diagram defined by the safety system of the machine 1.

As is known, the load diagram of a telescopic handler delimits space surrounding the machine 1 in confined areas, in which the movement of the load by the manoeuvring boom 10 is safe, with respect to the risk of instability. The delimitation of these zones is determined on the basis of the weight of the load.

In the example of FIG. 3, the diagram includes a first zone Z1 delimited by the perimeter P, Q, R, T1, wherein the anti-instability limiting function of the safety system, guaranteed by the processing unit 2, does not intervene. In effect, the first zone Z1 includes positions of the load which are adopted when the boom 10 moves towards the vertical, that is to say, in a condition in which the risk of longitudinal stability is lower.

However, in the first zone Z1 the “hydraulic stop” of the safety system intervenes, that is to say, the function for limiting the thrust force of the boom 10 described above.

In effect, since in this first zone Z1 the limitation of the longitudinal moment does not intervene (except at the line T1, as will be seen), the elongation of the boom 10 even with significant loads is not automatically limited by the processing unit 2. However, thanks to the advantageous feature of limiting the thrust force of the boom 10, in the above-mentioned manner, an excessive elongation of the boom 10 which produces stresses on the boom which are dangerous for its integrity are completely prevented.

The second zone Z2 è is defined by the first “vertical stop”. When the first stop line T1 is reached with a certain weight (in the example, 1200 kg) corresponding to the reference value associated with the above-mentioned linear distance of the load, which is recorded in the above-mentioned memory module 23, the movement of the boom 10 is prevented. For example, the distance taken into consideration may be that between the hinge 18 of the boom 10 and the first stop line T1, but reference points can also be adopted from which to calculate the position of the stop lines T1, T2, T3. . . . In practice, the operator is not allowed to move a load of that weight in the second zone Z2.

The same logic also applies in the other zones Z2, Z3, Z4, . . . , which can be reached, passing through the further stop lines T2, T3, T4 only by loads which are progressively lighter.

The invention also relates to an operating method of a working machine 1, which may be configured like the one described above, including one or more of its optional aspects.

The method comprises constraining to a predetermined maximum threshold the force exerted by the movement organ 10 to move the load. In this way, the “hydraulic stop” described above is obtained. If, as in telescopic handlers, the machine 1 is equipped with an manoeuvring boom 10 which is extensible and retractable, then the force for extension of the boom 10 may be limited by the predetermined maximum threshold. Preferably, a hydraulic cylinder 16 may be provided for extending and retracting the boom 10; in this case, under the working pressure of the cylinder 16 a predetermined maximum threshold is set, to define a maximum longitudinal operating extension allowed for the boom 10, as a function of the load.

The method may comprise the following steps:
detecting a position and a weight of the load;
comparing the weight of the load with a predetermined reference value, selected on the basis of a position of the load;
limiting the movement of the above-mentioned organ 10 based on the comparison performed.

Preferably, the reference value is independent of the angular position of the manoeuvring boom 10.

The proposed method may comprise further steps which correspond to respective functions performed by the machine 1 according to the invention illustrated in this description and which comprise providing devices or components of the machine 1.

1. A self-propelled working machine (1) provided with an organ (10) for moving a load comprising at least one activation actuator (14, 16), wherein a force exerted by said actuator (14, 16) is constrained by a predetermined maximum threshold.

2. The machine (1) according to claim 1, wherein said organ includes a manoeuvring boom (10) and said actuator (14, 16) is designed for moving the boom (10).

3. The machine (1) according to claim 2, wherein the manoeuvring boom (10) is extendible and retractable and said actuator (16) is suitable for actuating the extension and retraction of the boom (10).

4. The machine (1) according to claim 3, wherein the actuator is a hydraulic cylinder (16) the thrust force of which is constrained by a predetermined maximum pressure threshold, so as to define a maximum longitudinal operating extension allowed for the boom (10), as a function of the load.

5. The machine (1) according to claim 4, comprising a hydraulic circuit which includes said cylinder (16), the circuit being configured for supplying the cylinder (16) with a working fluid the pressure of which is limited by a maximum value corresponding to the predetermined maximum threshold.

6. The machine (1) according to claim 5, wherein said hydraulic circuit includes a hydraulic distributor (17) designed for supplying the cylinder (16) with a working fluid the pressure of which is limited by the above-mentioned maximum value.

7. The machine (1) according to claim 1, comprising a safety system designed to prevent a risk of instability, comprising means (3) for detecting a position and a weight of the load and comprising a processing unit (2) connected to said detection means and in turn comprising: a checking module (21) configured for comparing the weight of the load with a predetermined reference value, selected on the basis of a position of the load; and a limiting module (22) configured for producing at least one limiting signal suitable for limiting the movement of the above-mentioned movement organ (10), following the comparison performed by the checking module.

8. The machine (1) according to claim 7, wherein the movement organ includes a manoeuvring boom (10) which can be raised and lowered under the actuation of a first actuator (14) and which can be extended and retracted under the actuation of a second actuator (16), the operation of the first and the second actuator being subject to said limiting signal.

9. The machine (1) according to claim 8, wherein said reference value is independent of an angular position of the manoeuvring boom (10).

10. The machine (1) according to claim 9, wherein the first and the second actuators (14, 16) are of the hydraulic type, the machine (1) comprising a hydraulic distributor (17) designed for adjusting the functioning of the two hydraulic actuators and further designed to limit the actuation of the actuators following reception of the limiting signal from the processing unit (2).

11. An operating method of a working machine (1) provided with an organ (10) for moving a load, wherein a force exerted by the organ for moving the load is constrained by a predetermined maximum threshold.

12. The method according to claim 11, wherein said organ includes a manoeuvring boom (10) which is extendible and retractable, the extension force of which is limited by said predetermined maximum threshold.

13. The method according to claim 12, wherein a hydraulic cylinder (16) is provided for extending and retracting the boom (10) and wherein a predetermined maximum threshold is set to the operating pressure of the cylinder (16), thereby defining a maximum longitudinal operating extension allowed for the boom (10), as a function of the load.

14. The method according to claim 11, comprising the following steps:
detecting a position and a weight of the load;
comparing the weight of the load with a predetermined reference value, selected on the basis of a position of the load;
limiting or freely allowing movement of the above-mentioned organ (16) based on the comparison performed.

15. The method according to claim 14, wherein said reference value is independent of an angular position of the movement organ.
